(19) United States
(12) Patent Application Publication
(10) Pub. No.: US 2019/0169552 A1
(43) Pub. Date: Jun. 6, 2019

(54) Water-Soluble Encapsulated Chlorinating Agent

(71) Applicant: Scott Schaneville, St. Petersburg, FL (US)

(72) Inventor: Scott Schaneville, St. Petersburg, FL (US)

(21) Appl. No.: 15/829,129

(22) Filed: Dec. 1, 2017

(51) Int. Cl. C11D 17/04; C11D 3/48; C11D 3/28; A01N 25/34

(52) U.S. Cl. CPC C11D 17/042; C11D 3/48; A01N 43/707; A01N 25/34; A01N 2300/00; C11D 3/28

(57) ABSTRACT

The present invention is directed to materials and method of encapsulating chemical agents. In particular, the present invention is directed to compositions and methods of encapsulating a water chlorinating agent in a water soluble polymer encapsulant.

### FIELD OF THE INVENTION

The present invention relates to materials and methods for encapsulating chemical agents.

### BACKGROUND OF THE INVENTION

It is known in the art to package chemical agents in water soluble encapsulants, whereby a package placed into water so that the contents disperse in the water as the encapsulant dissolves. Water soluble packaging is advantageous in applications which employ hazardous chemicals as are found in, for example, agrochemicals, bleaching agents, laundry detergents, industrial chemicals, pool chemicals, and the like. Water soluble packaging allows a user to employ the hazardous substances without coming into direct contact with dangerous chemicals. Additionally, unit dose packaging obviates the need for the user to measure the chemicals since each dose is pre-packaged.

While current approaches provide films for use with certain chemicals, many of the modified films still exhibit a rapid reduction in solubility when exposed to aggressive oxidizing agents, and in particular chemicals that are useful for chlorinating water such as chlorinated isocyanurates. Accordingly, there exists a need for encapsulants having excellent water solubility even after prolonged exposure to aggressive oxidizing agents.

### SUMMARY OF THE INVENTION

The presently disclosed invention provides materials and methods for encapsulating chemicals used as chlorinating compounds in water.

One embodiment of the present invention composition comprises a water-soluble polymeric encapsulant and a water chlorinating agent encapsulated in the water soluble polymer encapsulant.

In certain embodiments of the present invention the water chlorinating agent comprises an alkali metal dichloroisocyanurate salt.

In some embodiments of the present invention the water chlorinating agent comprising sodium dichloroisocyanurate.

Embodiments of the present invention may be formulated in a unit or pod dosage form.

In embodiments of the present invention the water-soluble polymeric encapsulant may be in the form of a water-soluble film.

In further embodiments the water-soluble polymeric encapsulant may be a flexible water-soluble film.

In some embodiments of the present invention, the water-soluble polymeric encapsulant may be a self-supporting water-soluble film.

The present invention also contemplates embodiments where the water chlorinating agent is stable or inert with respect to the water-soluble polymeric encapsulant.

The present invention further contemplates embodiments where the water-soluble polymeric Embodiments of the present invention may further comprise one or more of: an active compound, a disinfectant, an antimicrobial, a sporocide, a stabilizing agent, and a colorant.

The present invention further contemplates embodiments where the water-soluble polymeric encapsulant being configured to provide timed release of the encapsulated water chlorinating agent over a period of about 1 minute to about 4 weeks.

### DETAILED DESCRIPTION OF THE INVENTION

In the following detailed description, the illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The present invention provides materials and methods for encapsulating sodium dichloroisocyanurate, or other similar chemicals used as chlorinating compounds in water. The final product also allows for the stable and safe storage of said chemical by providing a barrier that helps to maintain the chemical properties and desired effects of the encapsulated chemicals. The water soluble film is able to maintain the integrity of the encapsulated chemical while also providing the desired water solubility properties, such as the condition of water that it is being applied to, the temperature, and the desired delay in release of the encapsulated chemicals from a few seconds to hours.

In addition, this invention aims to provide final encapsulated pod products that can be of various weights, and dosages measured for specific application so that the end user will only need to place into a predetermined volume of water. This invention can be used for any body of water limitless of size and containment; such as, but not limited to, buckets, jugs, tanks, pools, tubs, lakes or any other containment of water that would require the application and treatment with the encapsulated chemical. The liquid, regardless of volume or type of containment, that the final product is placed into does not have to be of pure water, and can range from 0.1% to 100% water containing solution. It may contain various other substances, but not limited to, organic solvents, oils, biological material (human, animal, plant, bacteria, parasites, algae, etc), dissolved solids, suspending solids.

The self-supporting water soluble films embody the following properties: a specific matrix structure that allows for proper dissolution of the final product, flexibility of film so that it can be formed into various structures, the ability to cast, fuse, weld, or seal the film, and to be inert and stable toward the encapsulated sodium dichloroisocyanurate, or any other chemical that would typically be used as a chlorinating agent in water The water soluble films used to form the pods, and encapsulate sodium dichloroisocyanurate can also be formed with compounds incorporated into the matrix of the film; such as, but not limited to, active compounds, disinfectant, antimicrobials, sporocides, and stabilizing agents.

The composition of the water soluble films are mainly polymer based. The resulting film is self-supporting and is not dependent on the encapsulation of desired chemicals. The formed film also exhibit the ability to be temporarily heated and cooled again while maintain structural integrity. This property allows for the ability to form seals and join the films together and maybe used to seal, fuse, and weld a single piece or multiple pieces or layers of film to form a pod, pocket, pouch, or vessel. This property also allows for the formation of various three dimensional shapes of pods, pocket, pouched, or vessel because more than one piece of film can be sealed/fused together.

In addition, it is also possible to seal, fuse, weld more than one type of film together, thus forming a multilayered film, or forming a three dimensional structure composed of more than one type of film thus exhibiting different properties in regards to stability, uniformity, and solubility. This property can be used to form a pod, pocket, pouch, or vessel that are multi-chambered, and such structure maybe composed of the same film, various layers of film, or various layers of different films.

The formation of a multilayer or a multi-chambered final product allows for the ability to time release or delay release if desired. It maybe also used to incorporate various compounds that may be released in an ordered and desired pattern or sequence to achieve the desired effect of said combination, that would otherwise be ineffective or provide unwanted and undesired results if added all at once, or in the incorrect order.

In one instance, the self-supporting films are composed of a mixture of polymers, plasticizers, emulsifiers, bonding agents, bulking agents, fillers, and stabilizing agents. The desired composition chemicals and components can be mixed to form a homogenous emulsion of uniform consistency. This emulsion can then be cast in various forms, and heated to remove the solvent and form a self-supporting uniform film of unique properties such as stability, uniformity, and solubility.

In one instance, the self-supporting films are composed of a mixture of polymers, plasticizers, emulsifiers, bonding agents, bulking agents, fillers, and stabilizing agents. The desired composition chemicals and components can be premixed using various mixing methods to produce a uniform mixture of dry material that can then be heated via extrusion to form a self-supporting uniform film of unique properties such as stability, uniformity, and solubility. The final product, in such that, the sodium dichloroisocyanurate is enclosed within the self-supporting water soluble film can be that of a greater density than 1 g/cm³ and thus allow for the product to drop below the surface of the water when placed in. Alternatively, though the density of the final product is greater than 1 g/cm³, it is also possible to have the final product float on the surface of water through the entrapment of air during the formation of the pod with sodium dichloroisocyanurate contained within.

Sodium dichloroisocyanurate is typically used to sterilize and disinfect water, it can be used in pools or other similar bodies of water to provide a slow and constant source of chlorine. The structure of sodium dichloroisocyanurate can be of conflict when trying to encapsulate into PVA based films. The freely available hydrogen on the OH groups of PVA can be reacted and thus making the film insoluble. In addition, sodium dichloroisocyanurate can react with the moisture in the air to release free chlorine which then also reacts with the polymer backbone that typically compose PVA based films. Thus it is typically difficult to encapsulate sodium dichloroisocyanurate or other similar chlorinating agents, and specific formulation has to be formed to protect the polymer backbone, and to also create a film that is able to keep moisture out of the contents of the formed pod.

Typical PVA based film are not sufficient for the long term encapsulation of sodium dichloroisocyanurate due the reaction that occur with water that is absorbed through the film, and reactions that occur with the polymer that composes the film. Thus, this invention aims to greatly reduce and eliminate that incompatibilities that exist with the encapsulation of sodium dichloroisocyanurate into PVA based films. One such approach is to provide a barrier between the structure of PVA and sodium dichloroisocyanurate. This can be achieved through the addition of polyethylene glycol (PEG) to the mixture of formulation to provide a barrier against moisture in the resulting final film. In addition, sodium dodecyl sulfate can be added to allow for the uniform mixture of PEG into solution, and to provide additional assistance to the film's water solubility. A second approach is to provide a stabilizing agent that can counteract the effect of sodium dichloroisocyanurate. These compounds can be added to the formulation mixture, and remain embedded within the film, and protect the PVA polymer from reacting with sodium dichloroisocyanurate. Typically such agents would be toxic or harmful to ingest or be in contact with, thus it is difficult to find an agent that can stabilize sodium dichloroisocyanurate but be relatively safe for human exposure. One such compound is ascorbic acid, and it does provide the desired effect while remaining relatively safe for human contact. In addition, both methods can be combined to achieve an increase in effective stabilization towards interaction of sodium dichloroisocyanurate with the film.

In one embodiment, the emulsion mixture used for the preparation of the self-supporting film can be prepared as such. The mixing vessel is heated and once the water is at the desired temperature, the polymer mixture is added to the stirring solution, such as 88% hydrolyzed PVA. The mixture is stirred until uniform. To the mixture a stabilizing agent, such as ascorbic acid is added, followed by the addition of a surfactant, such as sodium dodecyl sulfate. Additional a moisture retention compound is added to mixture, such as polyethylene glycol (PEG). The mixture solution should at this point be an emulsion of homogenous and uniform consistency. Additionally a coloring agent may be added to the final solution thus allowing for colored film to be obtained.

In addition, the same mixture of chemicals used to form a homogenous emulsion solution for casting and film formation, can be also be mixed into a dry homogenous mixture. This mixture can then be put through an extruder, maybe heated, and produce a ready film that should obtain the same properties as one formed from an emulsion mixture.

The modified emulsion can be introduced in a vessel and then cast into a film. The processing can be any processing that can take an emulsion and form it into a film, which processing steps are not limited to those described herein. Examples can include extrusion, solution casting box apparatus, reverse roll coating casting, and other solution casting apparatus' known to those skilled in the art of solution casting. In this embodiment, the modified emulsion can be passed between rollers (e.g., casting rollers), and rolled onto a substrate at the desired wet gauge thickness. The substrate can be a wax or silicone coated substrate that allows the film to be peeled therefrom once the film is stable. The rollers can be adjusted to change the gap there between to change the wet gauge thickness of the film. Once on the substrate, the film can be cured and solidified, such as by heating. In one example, the film on the substrate can be passed through a heater (e.g., infrared heater) with air flow to provide convection heating, which is regulated to remove moisture from the film. The film can be formed in this matter to inhibit rippling or other unfavorable characteristics, and may avoid blistering. Good throughout heating and curing can produce the desired film. Once the film is formed, the film can be separated from the substrate. Such separation can include peeling, slicing, or parting the film from the substrate. The film can then be used in whole or cut into desired sizes.

In one example, the emulsion mixture is formed following this procedure. To a reaction vessel that is heated using a water jacket, D.I. water is added and the heat is set to a range of 30 C to 100 C, or 50 to 80 C, or to approx. 70 C. Once the water is at desired temperature, the mixture is stirred at approx. 300 RPM (this can vary). The first compound to be added to the heated solution is sodium dodecyl sulfate. Allowing some time to stir to uniformity, polyethylene glycol is added to the stirring mixture. To this mixture then add ascorbic acid. Once stirred to uniformity, the 88% hydrolyzed polyvinyl alcohol powder is added to the mixture thus forming the backbone matrix of the film. Blue coloring is finally added to obtain the desired color of the final film. The mixture is then extracted from the vessel, and allowed to degas in a sealed container, until the solution is free of all major trapped gases. This solution is thus ready to be cast and formed into the final desired film or desired properties for encapsulation of sodium dichloroisocyanurate.

The emulsion can be taken from the existing mixing vessel or put into a run tank vessel and then it is cast on a line. The process uses a very unique reversal roll method between two stainless steel rollers. The casting roller in the front dictates the speed of the line. A wax coated carrier paper or silicone paper or other coated or uncoated paper or other material starts at the casting box and can be used to carry the film forming composition through the oven. The film is cast at the desired thickness to get a final thickness, and it goes through an infrared heater system, which has convection air flowing through from an exhaust fan to help draw the moisture off the film. Good convection air flow in the tunnel that keeps the moisture coming off at a constant rate and as long as the line speeds matched with the temperature settings correctly, the process provides good uniform drying that doesn't have underneath wet spots under the film top layer.

The film is cast at the desired wet thickness to get the desired final thickness of the partially or completely dehydrated film. The Film is dehydrated as it is carried through an infrared heater system, which has convection air flowing through from an exhaust fan to help draw the moisture off the film. By generating adequate convection air flow through the oven tunnel, moisture is evaporated from the film at a constant rate. When the speed of drying and the temperature settings are sufficiently matched, the end result is an evenly dried film. This controlled heating and uniform heat application prevent the film from drying at an uneven pace which may cause a dried exterior covering wet film. The dried film is collected on a spool containing the carrier paper (or other carrier medium) and the film at the end of the oven system.

In addition, the ingredients may also be formed into the final film via the use of an extrusion method technique by those skilled in the art.

Alternative Polymers that can be Used Individually or in Combination:

Poly(2-hydroxypropyl methacrylate), Poly(2-ethyl-2-oxazoline) [MW 200,000], Poly(2-ethyl-2-oxazoline) [MW 500,000], Poly(2-ethyl-2-oxazoline) [MW 500,000], Polyacrylamide (MW 400,000-1,000,000), Poly(3-chloro-2-hydroxypropyl-2-methacryloxyethyldimethylammonium chloride), Poly(acrylamide/2-methacryloxyethyltrimethylammonium bromide) 80:20, 20% aq. Soln., Poly(vinylamine) hydrochloride, Poly(l-lysine hydrobromide) [MW 80,000] 0.1% Solution, Poly(2-vinylpyridine) [MW 300,000-400,000], Poly(4-vinylpyridine), Poly(ethylene oxide-b-propylene oxide) [ratio 0.33:1], Poly(ethylene oxide-b-propylene oxide) [ratio 0.8:1], Poly(ethylene oxide-b-propyleneoxide), Poly(methacrylic acid), Poly(methacrylic acid) sodium salt, 30% soln. in water, Polypropylene, Isotactic, Poly(vinyl methyl ether), 50% methanol solution, Poly(styrenesulfonic acid), sodium salt (MW 1,000,000), Poly(N-methyl N-vinyl acetamide) homopolymer, Poly(n-butyl acrylate/2-methacryloxyethyltrimethylammonium bromide) 80:20, Dextran, Poly(vinylsulfonic acid) sodium salt, 25% soln. in water, Dextran, DEAE ether, Cellulose, methyl hydroxyethyl ether, Dextran, hydrogenated, Poly(acrylamide/acrylic acid), potassium salt, crosslinked, Poly(vinyl methyl ether), 50% aqueous solution, Poly(oxyethylene) sorbitan monolaurate (Tween 20®), Poly(vinyl alcohol) [MW ˜108,000], Poly(vinyl alcohol) [98 mol. % hydrolyzed], Dextran, Dextran [MW 100,000-200,000], Dextran [MW 200,000-300,000], Dextran [MW 3,000,000-7,000,000], Cellulose, hydroxyethyl ether (MW 1,000,000), Cellulose, hydroxyethyl ether (MW 720,000), Cellulose, hydroxyethyl ether (MW ˜90,000), Poly(ethylene oxide) [MW 100,000], Poly(acrylic acid), 63% soln. in water [MW ˜2,000], Poly(N-iso-propylacrylamide), Poly(Allyl Amine), Mw 15,000, Poly(2-hydroxyethyl methacrylate/methacrylic acid) 90:10, Poly(acrylamide/acrylic acid) [60:40], Polymethacrylamide, Poly(2-methacryloxyethyltrimethylammonium bromide), 20% soln. in water, Poly(N-vinylpyrrolidone), MW 10,000, Poly(N-vinylpyrrolidone), Pharmaceutical grade, MW 40,000, Poly(2-vinylpyridine) [MW 200,000-400,000], Poly(2-vinylpyridine) [MW 40,000], Poly(N-vinylpyrrolidone/2-dimethylaminoethyl methacrylate), dimethyl sulfate quaternary, Poly(4-vinylpyridine N-oxide), Guar Gum, Poly(ethylene oxide-b-propylene oxide) [ratio 0.15:1], Poly(ethylene oxide-b-propylene oxide) [ratio 0.15:1], Poly(ethyl acrylate/acrylic acid), Poly(ethylene/acrylic acid) 92:8, Poly(acrylic acid), sodium salt, 40% soln. in water [MW ˜3,000], Poly(acrylic acid), powder [MW ˜4,000,000], Poly(acrylic acid), ammonium salt, powder [MW 250,000], Poly(vinyl phosphoric acid), sodium salt, Poly(styrenesulfonic acid), sodium salt (MW 75,000), Poly(N-vinylpyrrolidone/vinyl acetate) [70:30], Poly(N-vinylpyrrolidone/vinyl acetate) [50:50], Poly(N-vinylpyrrolidone/vinyl acetate) [30:70], Poly(N-vinylpyrrolidone), MW 4,000-6,000, Poly(acrylic acid), sodium salt, crosslinked, Poly(ethylene oxide) [MW 200,000], Poly(ethylene oxide) [MW 5,000,000], Poly(l-lysine hydrobromide) [MW 275,000], Poly(diallyldimethylammonium chloride) [MW ˜240,000], Powder, Poly(2-vinyl-1-methylpyridinium bromide), 20% soln. in water, Poly(4-vinylpyridine), Poly(ethylene oxide-b-propylene oxide) [ratio 3:1], Poly(styrenesulfonic acid/maleic acid), sodium salt, Poly(methacrylic acid) ammonium salt, 30% soln. in water, Poly(acrylic acid), powder [MW ˜1,000,000], Poly(acrylic acid), sodium salt, powder (MW ˜2,000), Poly(vinyl acetate), Poly(vinyl acetate), 40% hydrolyzed, Poly(ethylene oxide) [MW 300,000], Poly(ethylene oxide) [MW 600,000], Dextran sulfate, sodium salt, Poly(ethylene oxide) [MW 8,000,000], Poly(vinyl alcohol) [MW 78,000], Poly(vinyl alcohol) [88 mol. % hydrolyzed], Poly(1-glycerol methacrylate), Polyacrylamide (MW 5,000,000), 1% aq soln, Poly(butadiene/maleic acid) 1:1, 42% soln. in water, Poly(acrylic acid), sodium salt, powder [MW ˜6,000], Polypropylene, Poly(ethylene oxide) [MW 4,000,000], Poly(vinyl alcohol) [MW 133,000], Poly(vinyl alcohol) [MW ˜25,000], Poly(2-ethyl-2-oxazoline) [MW 50,000], Poly(l-lysine hydrobromide) [MW 50,000], Poly(N-vinylpyrrolidone), MW 40,000, Poly(N-vinylacetamide), Poly(2-ethyl-2-oxazoline) [MW 5,000], Poly(acrylamide/sodium acrylate) [70:30], Chitosan, Purified Powder MW ˜15,000, Poly(acrylic acid), 25% soln. in water [Mw ˜345,000], Poly(acrylic acid), sodium salt, 20% soln. in water [MW ˜225,000], Poly(ethylene oxide) [MW 1,000,000], Poly(acrylic acid), sodium salt, 35% soln. in water [MW ˜60,000], Poly(acrylic acid), powder [MW ˜450,000], Poly(styrenesulfonic acid), 30% soln. in water, Polypropylene, Chromatographic Grade, Poly(N-vinylpyrrolidone), MW 2,500, Poly(l-lysine hydrobromide) [MW 120,000], Poly(Diallyl Dimethyl Ammonium Chloride) [Mw ˜8,500], 28 wt. % in H2O, Poly(acrylamide/acrylic acid), Poly(vinyl alcohol), N-methyl-4(4′-formylstyryl)pyridinium methosulfate acetal, Poly(vinylphosphonic acid), 30% Soln., Poly(vinyl alcohol) [MW 6,000], Poly(N-vinylpyrrolidone), MW 1,000,000, Poly(acrylic acid), 50% soln. in water [MW ˜5,000], Poly(vinyl alcohol) [MW 25,000], Poly(acrylic acid), 25% soln. in water [MW ˜50,000]

Alternative Plasticizers/Moisture Retention Compounds:

Glycerol/glycerin; Propylene Glycol; Fatty acids; Vegetable oil; Vegetable shortening; Olive oil; Soybean oil; Grape seed oil; Sunflower oil; Peanut oil; Corn oil; Canola oil; Rice Bran oil; Lard; Suet; Butter or Coconut oil.

Alternative Surfactants:

Polysorbate 20 (polyoxyethylene (20) sorbitan 15 monolaurate); Polysorbate 40 (polyoxyethylene (20) sorbitan monopalmitate); Polysorbate 60 (polyoxyethylene (20) sorbitan monostearate); Polysorbate 80 (polyoxyethylene (20) sorbitan monooleate); Polyethylene glycol; Monoglycerides; Diglycerides; Triglycerides; Phospholipids; Lecithin; Sodium bis(2-ethylhexyl) sulfosuccinate (AOT); or sodium mono- and dimethylnaphthalene sulfonate (SMDNS).

Additional examples and data may be found in the Appendix attached hereto.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

1. A composition, comprising:
a water-soluble polymeric encapsulant; and
a water chlorinating agent encapsulated in the water soluble polymer encapsulant.

2. The composition of claim 1, the water chlorinating agent comprising an alkali metal dichloroisocyanurate salt.

3. The composition of claim 1, the water chlorinating agent comprising sodium dichloroisocyanurate.

4. The composition of claim 1, formulated in a unit or pod dosage form.

5. The composition of claim 1, the water-soluble polymeric encapsulant being a water-soluble film.

6. The composition of claim 1, the water-soluble polymeric encapsulant being a flexible water-soluble film.

7. The composition of claim 1, the water-soluble polymeric encapsulant being a self-supporting water-soluble film.

8. The composition of claim 1, the water chlorinating agent being stable or inert with respect to the water-soluble polymeric encapsulant.

9. The composition of claim 1, the water-soluble polymeric encapsulant rendering the encapsulated water chlorinating agent stable or inert.

10. The composition of claim 1, further comprising one or more of: an active compound, a disinfectant, an antimicrobial, a sporocide, a stabilizing agent, and a colorant.

11. The composition of claim 1, the water-soluble polymeric encapsulant being configured to provide timed release of the encapsulated water chlorinating agent over a period of about 1 minute to about 4 weeks.

12. The composition of claim 1, the water-soluble polymeric encapsulant being configured to provide time-delayed release of the encapsulated water chlorinating agent with a release time beginning from about 1 minute to about 4 weeks.

13. The composition of claim 1, the water-soluble polymeric encapsulant being formed into a plurality of films, at least a first film in the plurality of films encapsulating the water chlorinating agent, and a second film in the plurality of films encapsulating nothing, or one or more of the water chlorinating agent, an active compound, a disinfectant, an antimicrobial, a sporocide, a stabilizing agent, and a colorant.

14. The composition of claim 13, the plurality of films being configured for sequential dissolution.

15. The composition of claim 1, the water-soluble polymeric encapsulant being formed into a plurality of films, at least a first film in the plurality of films encapsulating the water chlorinating agent, and a second film in the plurality of films encapsulating one or more of the water chlorinating agent, an active compound, a disinfectant, an antimicrobial, a sporocide, a stabilizing agent, and a colorant, the plurality of films being configured for sequential dissolution effective to sequentially release an encapsulant in each of the plurality of films.

16. The composition of claim 1, the water-soluble polymeric encapsulant comprising one or more polymers, plasticizers, emulsifiers, bonding agents, bulking agents, fillers, and stabilizing agents.

17. The composition of claim 1, the composition having a density greater than 1 gram per cc.

18. The composition of claim 1, the composition having a density less than 1 gram per cc.

19. The composition of claim 1, formed in a unit dose configuration effective to enclose one or more hollow pocket that give the composition an effective density less than 1 gram per cc.

20. A method, comprising:
providing a composition, comprising:
a water-soluble polymeric encapsulant; and
a water chlorinating agent encapsulated in the water soluble polymer encapsulant; and
chlorinating a portion of water by contacting the composition to the portion of water effective to cause at least partial dissolution of the water-soluble polymeric encapsulant effective to release the encapsulated water chlorinating agent to the portion of water.

21. The method of claim 20, comprising providing the composition according to any of claims 1-19.

22. A method, comprising:
providing a water-soluble polymeric encapsulant;
providing a water chlorinating agent; and
encapsulating the water chlorinating agent in the water soluble polymer encapsulant.

23. The method of claim 22, comprising encapsulating the water chlorinating agent in the water soluble polymer encapsulant to form the composition according to any of claims 1-19.

24. A kit, comprising:
a composition, comprising:
a water-soluble polymeric encapsulant; and
a water chlorinating agent encapsulated in the water soluble polymer encapsulant; and instructions, the instructions directing a user to chlorinate a portion of water by contacting the composition to the portion of water effective to cause at least partial dissolution of the water-soluble polymeric encapsulant effective to release the encapsulated water chlorinating agent to the portion of water.

25. The kit of claim 24, comprising the composition according to any of claims 1-19.
